(19) United States
(12) Patent Application Publication
(10) Pub. No.: US 2007/0277190 A1
(43) Pub. Date: Nov. 29, 2007

(54) DISK REPRODUCING DEVICE WITH DISK CLAMP MECHANISM

(75) Inventor: Masahiko NISHIDE, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/750,582

(22) Filed: May 18, 2007

(30) Foreign Application Priority Data
May 23, 2006 (JP) 2006-142667

(51) Int. Cl. G11B 17/028

(52) U.S. Cl. 720/712

(57) ABSTRACT

The present invention provides a disk reproducing device with a disk clamp mechanism capable of securely grasping a disk and making the device smaller. An inclined portion and a clamper supporting annular portion are formed in a clamper support plate, and a clamper is mounted in an opening formed in the inner circumference of the damper supporting annular portion. Thereby, even if an upper brim portion is located in the middle of the inclined portion when a disk is removed, the upper brim portion slides down along the inclined portion so that the clamper is placed on the damper supporting annular portion. When the disk is again inserted and rotated, the disk can be securely grasped between the clamper and a turntable without a displacement of the clamper. Further, the inclined portion can improve the strength of the damper supporting annular portion, thereby making it possible to thin the clamper supporting annular portion.

The present application is based on and claims priority of Japanese patent application No. 2006-142667 filed on May 23, 2006, the entire contents of which are hereby incorporated by reference.

### BACKGROUND OF THE INVENTION

1. Field of the Invention

The present invention relates to a disk reproducing device with a disk clamp mechanism capable of securely grasping a disk between a clamper and a turntable.

2. Description of the Related Art

In the past, as shown in FIG. 5, a recording medium (hereinafter referred to as a disk) carried in a device by a carrying mechanism is grasped from both the recording and label surfaces of the disk between a turntable having a projection in the center of the top surface and a damper having a brim portion formed on the upper surface of a substantially cylinder shape and a recess formed in the center of the lower surface and is rotated by the driving force of a motor coupled to the turntable so that data reading and writing is performed on the recording surface. The clamper is suspended by a support portion provided at the upper part of a frame constituting the appearance of the recording and reproducing device, and the turntable is mounted on a chassis, as a major component of a traverse unit mounted in the frame. Further, the damper is mounted for vertical motion within a predetermined range and rotation by the support portion. One end of the chassis is joined to the frame, and the other end is joined in a manner to be slidable vertically in conjunction with a cam plate. The cam plate is also in conjunction with the carrying operation of a disk tray.

That is, with the above-described disk grasp structure, the disk tray carries the disk into the frame; the cam plate slides when the disk reaches a predetermined position; the chassis moves rotationally in conjunction with the slide of the cam plate, with the joint to the frame acting as a fulcrum; the turntable mounted on the chassis moves up and fits an opening formed in the center of the disk; and the chassis further moves up, so that the turntable and the damper disposed at the opposite side of the disk from the turntable can grasp the disk. At this time, the clamper does not touch the support portion so as to be rotatable. In many cases, for a firmer grasp, a magnet is mounted on each of the damper and the turntable, or a magnet is mounted on one of the damper and the turntable and a magnetic substance is mounted on the other.

However, in the above structure, as shown in FIGS. 6 and 7, the damper is displaced off center due to a space for enabling the clamper to be rotatable with respect to the support portion, and the outer edge of the damper is stuck on the projection of the turntable, thereby causing noise when the clamper is pulled by magnetic force to grasp the disk. Further, the catching of the turntable is performed with the damper being off center, thereby causing the acceleration of the support portion wear.

In order to solve this problem, Japanese Unexamined Patent Application Publication No. 2004-30806 (patent document 1) discloses a structure in which a damper support portion has an inclination of 45 degrees. With this structure, even if the damper is displaced off center, the brim portion of the damper slides down along the inclination, which can return the damper to a predetermined position.

However, with the structure disclosed in patent document 1, there are cases where the clamper is out of the level with respect to a damper holding portion because one point of the perimeter of the clamper brim portion abuts on the damper holding portion lower or upper than the other.

### SUMMARY OF THE INVENTION

The present invention has been made in view of the above circumstance, and it is an object of the invention to provide a disk reproducing device with a disk clamp mechanism in which a turntable having a disk placed thereon and a clamper can prevent a displacement by holding the damper correctly in the center with respect to a damper holding portion.

A first aspect of the invention relates to a disk reproducing device with a disk clamp mechanism including a turntable for rotating a disk placed thereon, a damper for clamping the disk onto the turntable, and a clamper support plate for supporting the clamper, wherein the damper support plate is formed with a panel-like member constructed of an injection molded component, a damper mounting hole for receiving the damper is formed in the damper support plate, a clamper supporting annular portion which is thinner than the thickness of the damper support plate is formed around the periphery of the damper mounting hole, and an inclined portion having a predetermined inclination is formed around the outer edge of the clamper supporting annular portion.

According to the first aspect of the invention, the damper supporting annular portion enables the damper to be placed horizontally, and the inclined portion formed around the outer edge of the clamper supporting annular portion enables the clamper to slide down along the inclined portion due to the clamper's own weight so that the damper can be securely placed on the clamper supporting annular portion.

A second aspect of the invention relates to the disk reproducing device with a disk clamp mechanism according to the first aspect, wherein the diameter of the most outer circumference of the damper supporting annular portion is substantially the same as the outer diameter of an upper brim portion of the clamper.

According to the second aspect of the invention, when the turntable moves up and rotates to read a disk, the damper does not touch the inclined portion, and in a state where the clamper and the turntable do not grasp the disk after the turntable moves down, the clamper brim portion can fit the most inner circumference of the inclined portion.

### BRIEF DESCRIPTION OF THE DRAWINGS

An embodiment of the present invention will be described in detail based on the following figures, wherein:

FIG. 1 is a cross-sectional view showing a disk device according to an embodiment of the present invention;

FIG. 2 is a cross-sectional view showing a state in which the disk device has grasped the disk;

FIG. 3A is an enlarged fragmentary sectional view showing a state before a clamper slides down along an inclined portion;

FIG. 3B is an enlarged fragmentary sectional view showing a state after the clamper slides down along the inclined portion;

FIG. 4 is an enlarged fragmentary sectional view showing the dimensions of a damper support plate, an inclined portion, a clamper supporting annular portion, and a clamper;

FIG. 5 is a cross-sectional view of a conventional disk device in a state before a disk is not grasped;

FIG. 6 is a cross-sectional view of the conventional disk device in a state in which a clamper is displaced with respect to a turntable at the time of grasping a disk; and

FIG. 7 is a cross-sectional view of the conventional disk device in a state after the disk is grasped between the damper and the turntable.

### DESCRIPTION OF THE PREFERRED EMBODIMENTS

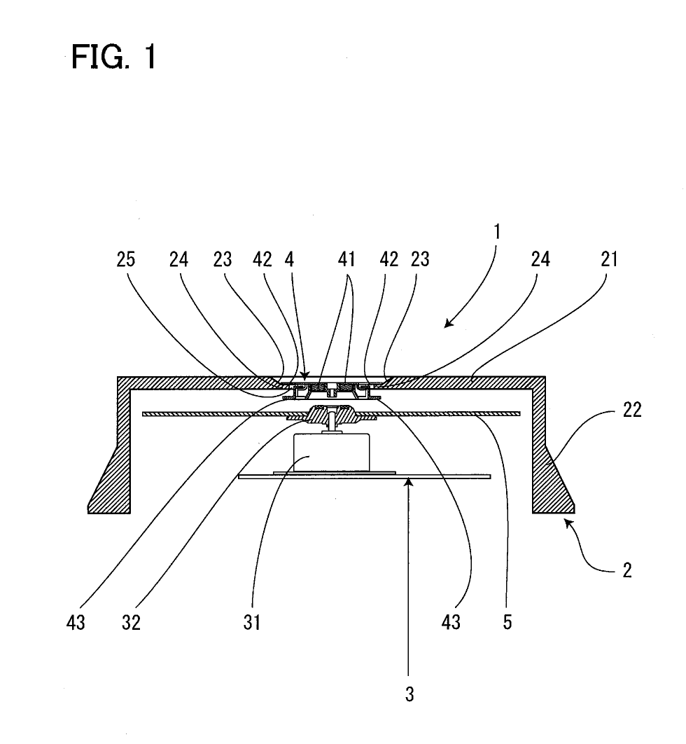

Hereinafter, an embodiment as the best mode for carrying out the present invention will be described with reference to FIGS. 1 to 4. Needless to say, the invention is easily applicable to structures other than that described in the embodiment within the scope of the invention.

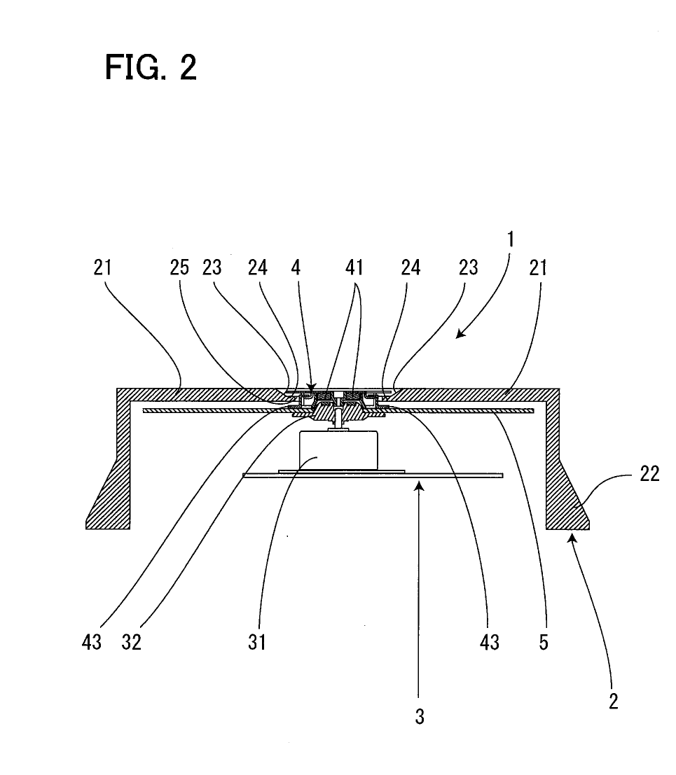

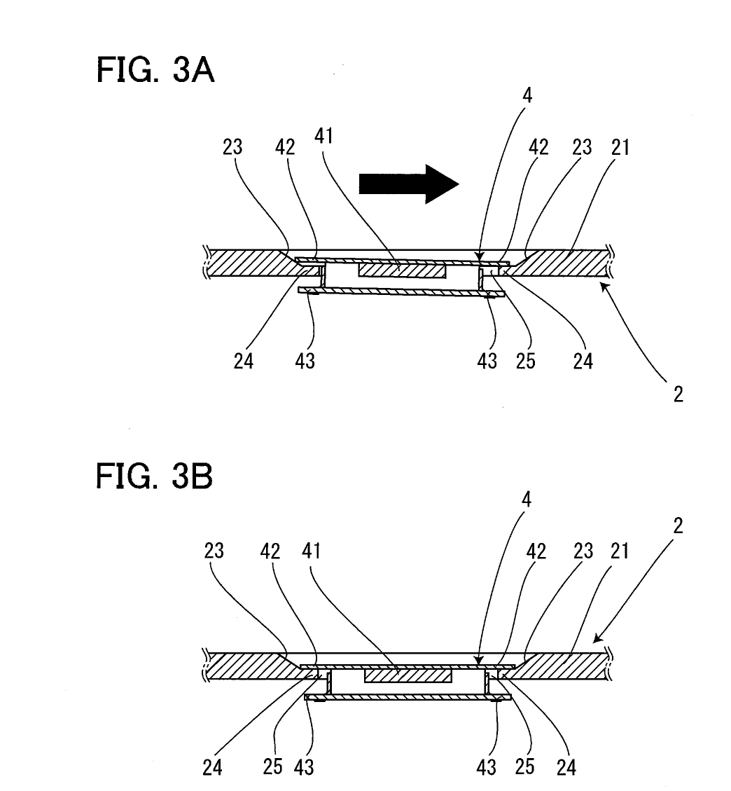

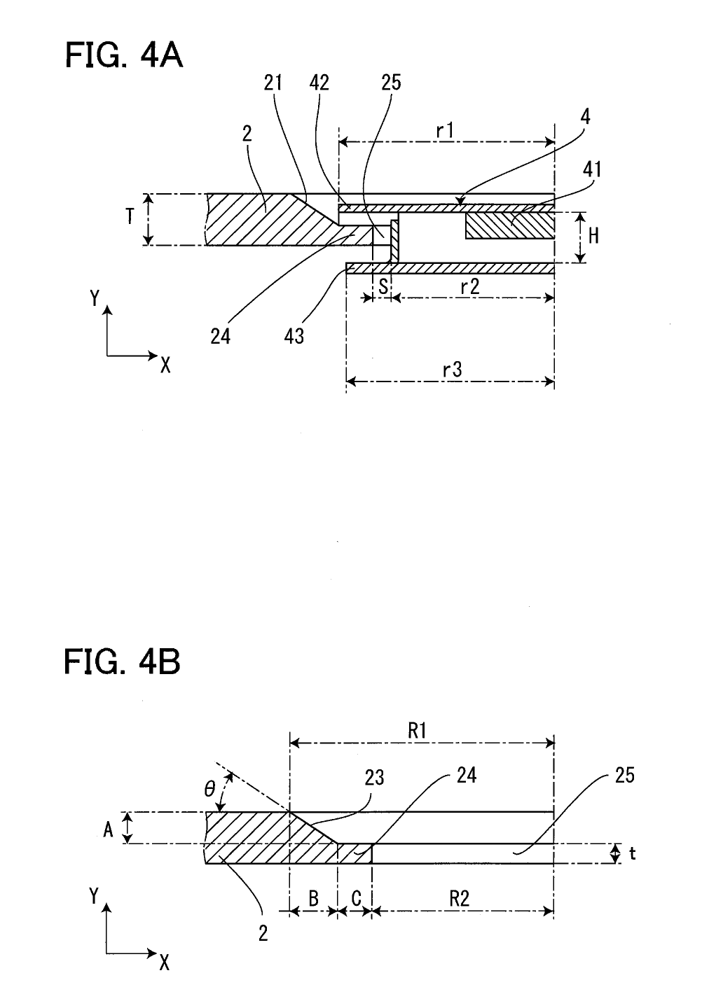

FIGS. 1 to 4 are illustrations showing a disk device according to one embodiment of the invention. FIG. 1 is a cross-sectional view showing the disk device in a state before a disk is not grasped between a damper and a turntable. FIG. 2 is a cross-sectional view showing the disk device in a state after the disk is grasped between the clamper and the turntable. FIGS. 3A and 3B are enlarged cross-sectional views showing the clamper and a damper support plate before the turntable moves up, in which FIG. 3A shows a state where the damper is displaced and a brim portion of the damper abuts on an inclined portion, and FIG. 3B shows a state where the damper is placed on a damper supporting annular portion. FIGS. 4A and 4B are enlarged cross-sectional views illustrating the relationship between the dimensions of the clamper, the damper supporting annular portion, and the clamper support plate and the inclination of the inclined portion.

The structure of the disk device according to this embodiment will be described with reference to FIG. 1. Reference numeral 1 denotes a disk device in which the structure of a damper and a clamper support plate according to the invention is adopted. Reference numeral 2 denotes a resin frame; 21, a clamper support plate; 22, a frame leg portion; 23, an inclined portion; 24, a damper supporting annular portion; and 25, a clamper mounting hole. Reference numeral 3 denotes a traverse unit; 31, a motor; and 32, turntable. Reference numeral 4 denotes a clamper; 41, a magnetic substance for improving the catching reliability of the turntable 32; 42, an upper brim portion formed on the upper surface of the clamper; and 43, a lower brim portion formed on the lower surface of the clamper. The clamper 4 is inserted into the damper mounting hole 25 and mounted in the resin frame 2. Reference numeral 5 denotes a disk as a recording medium. In FIG. 2, the damper 4 has caught the turntable 32 and grasped the disk 5.

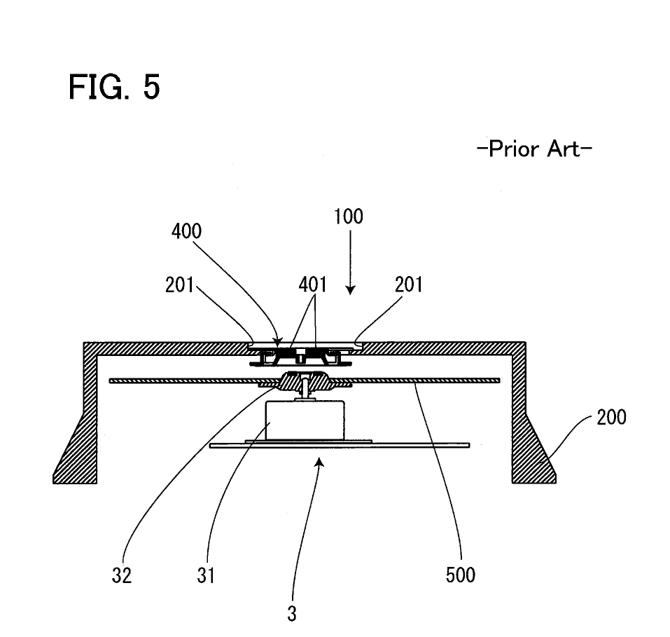

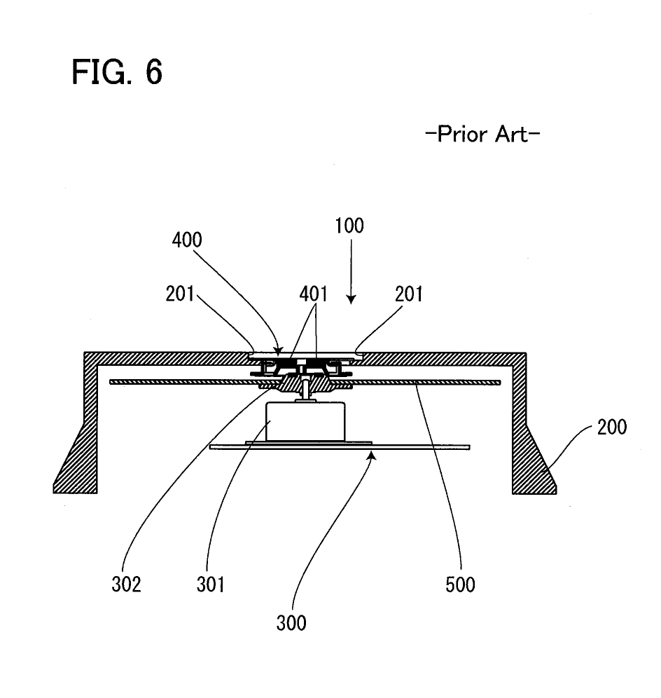

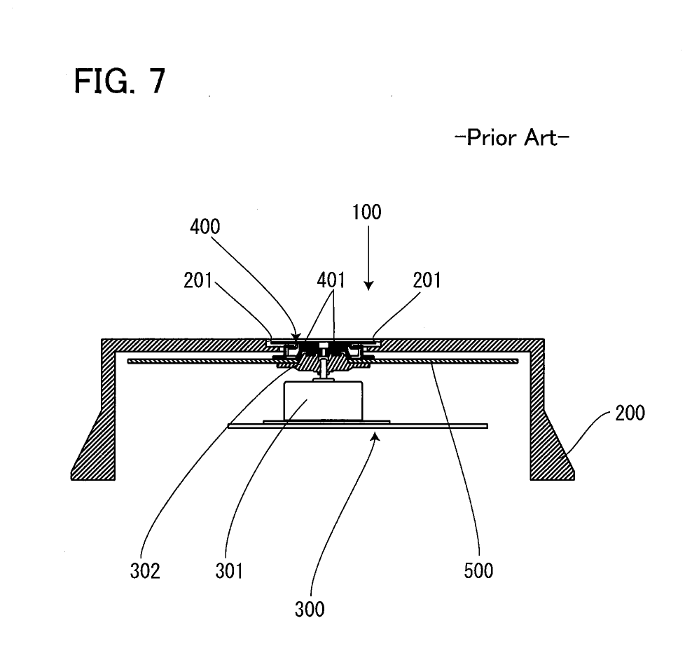

Next, the state of the damper 4 in which the disk 5 is not grasped will be described with reference to FIG. 3. When the turntable 32 is separated from the clamper 4 after the completion of grasping of the disk 5, the damper 4 may be displaced. FIG. 3A shows the state where the clamper 4 is displaced. At this time, the upper brim portion 42 slides down along the inclined portion 23 due to the weight of the clamper 4. As shown in FIG. 3B, the damper 4 is placed on the damper supporting annular portion 24 and positioned by the most inner circumference of the inclined portion 23. Further, with this structure, as to the most inner circumference of the inclined portion 23, a dimension in the radial direction of the damper supporting annular portion 24 can be shortened compared to the position of a clamper support portion 201 of a conventional disk device 100 shown in FIG. 5, thereby making it possible to improve the strength of the clamper supporting annular portion 24 thinner than the damper support plate 21.

Next, the structure in which the inclined portion 23 increases the strength of the clamper supporting annular portion 24 for a thinner form will be described with reference to FIG. 4. The height (dimension in the Y-axis direction) A of the inclined portion 23 is the difference between the thickness (dimension in the Y-axis direction) T of the damper support plate 21 and the thickness (dimension in the Y-axis direction) t of the clamper supporting annular portion 24 on which the damper 4 actually abuts, as expressed in equation (1).

A=T−t (1)

Thus, the thickness A of the inclined portion 23 formed in this embodiment is provided in accordance with equation (1). Further, a dimension C in the radial direction (X-axis direction) of the damper supporting annular portion 24 on which the upper portion of the damper 4 abuts is expressed by equation (2), using the radius R1 of the most outer circumference of the inclined portion 23, the radius R2 of the most inner circumference of the damper supporting annular portion 24, and a dimension B in the radial direction (X-axis direction) of the inclined portion 23.

C=(R1−R2)−B (2)

Since the inclined portion 23 needs to control the position of the damper 4, it is necessary to satisfy equation (3) which is a condition indicated by using the radius r1 of the most inner circumference of the inclined portion 23, the radius r2 of the cylinder portion of the clamper 4, and a space S formed by the clamper 4 placed in the center of the damper mounting hole 25 and the damper supporting annular portion 24.

C≦r1−(r2+S) (3)

### Hereinafter, a description will be made based on the state of equation (4).

C=r1−(r2+S) (4)

Based on the condition of equation (4), the dimension C in the radial direction of the damper supporting annular portion 24 is provided within the limits of the radius of the brim portion 42 formed on the upper portion of the damper 4. In other words, the dimension C should be such that the clamper 4 does not slip off the clamper supporting annular portion 24. Since the clamper 4 is required to be mounted for vertical motion and rotation with respect to the damper supporting annular portion 24, the space S formed by the clamper 4 placed in the center of the clamper mounting hole 25 and the damper supporting annular portion 24 needs to satisfy the conditions of equations (5) and (6).

0<S<r1−r2 (5)

0<S<r3−r2 (6)

### The dimension B in the radial direction of the inclined portion 23 can be expressed by equation (7) from equation (2).

B=(R1−R2)−C (7)

### By substituting equation (4) into equation (7), the dimension

B in the radial direction of the inclined portion 23 can be expressed by equation (8).

$$\begin{matrix}B = ( R 1 - R 2 ) - [ r 1 - ( r 2 + S ) ] \\ = ( R 1 - R 2 ) - r 1 + ( r 2 + S )\end{matrix} \qquad ( 8 )$$

### It is obvious from FIG. 4A that the radius R2 of the most inner circumference of the damper supporting annular portion 24 is expressed by the following equation (9).

r2+S=R2 (9)

### By substituting equation (9) into equation (8), the dimension B in the radial direction of the inclined portion 23 is obtained.

$$\begin{matrix}B = ( R 1 - R 2 ) - r 1 + R 2 \\ = R 1 - r 1\end{matrix} \qquad ( 10 )$$

### Further, the angle θ of the inclined portion 23 can be expressed by the following equation (11).

$$\begin{matrix}θ = {tan}^{- 1} ( A / B ) \\ = {tan}^{- 1} [ ( T - t ) / ( R 1 - r 1 ) ]\end{matrix} \qquad ( 11 )$$

### The dimension B in the radial direction of the inclined portion 23 satisfies the condition of equation (12).

B≧R1−r1 (12)

As to the radius R1 of the most outer circumference of the inclined portion 23, the dimension in the fore-and-aft (tray carrying) direction of the damper support plate 21 formed integrally with the resin frame 2 is restricted due to a mold draft; therefore, the inclined portion 23 is provided such that the angle θ is small. That is, the radius of the inner circumference of the clamper supporting annular portion 24 is reduced, thereby making it possible to decrease the thickness t of the clamper supporting annular portion 24 on which the brim portion 42 of the damper 4 abuts. Further, the dimension H from the undersurface of the brim portion 42 of the damper 4 to the top surface of the brim portion 43 of the damper 4 is expressed as follows:

H=t+K (13)

where the constant K denotes the range of movement. By decreasing the thickness t of the clamper supporting annular portion 24 on which the brim portion 42 abuts, it is possible to reduce the dimension H and thereby slim down the whole disk device.

With the above-described structure of the disk device 1, the inclined portion 23 can improve the strength of the clamper supporting annular portion 24 and correct the displacement of the damper 4. Further, by decreasing the angle of the inclined portion 23, it is possible to reduce the thickness of the damper supporting annular portion 24 while maintaining the strength thereof, thus contributing to size reduction of the disk device.

It should be understood by those skilled in the art that various modifications, combinations, sub-combinations and alterations may occur depending on design requirements and other factors insofar as they are within the scope of the appended claims or the equivalents thereof.

The effects of the present invention are as follows.

The first aspect of the invention provides a disk reproducing device with a disk clamp mechanism including a turntable for rotating a disk placed thereon, a damper for clamping the disk onto the turntable, and a clamper support plate for supporting the clamper, wherein the clamper support plate is formed with a panel-like member constructed of an injection molded component, a clamper mounting hole for receiving the clamper is formed in the clamper support plate, a clamper supporting annular portion which is thinner than the thickness of the clamper support plate is formed around the periphery of the clamper mounting hole, and an inclined portion having a predetermined inclination is formed around the outer edge of the clamper supporting annular portion. Therefore, the clamper which slides down along the inclined portion to be centered can be securely held at a predetermined position on the clamper supporting annular portion, thus making it possible to prevent a displacement between the turntable and the clamper when the turntable moves up to grasp the disk between the turntable and the clamper grasp.

The second aspect of the invention provides the disk reproducing device with a disk clamp mechanism according to the first aspect, wherein the diameter of the most outer circumference of the clamper supporting annular portion is substantially the same as the outer diameter of an upper brim portion of the clamper. Therefore, the clamper fits the most inner circumference of the inclined portion on the clamper supporting annular portion, thereby securely enabling the centering of the clamper. Further, the clamper supporting annular portion thinner than the clamper support plate is formed around the inner circumference of the inclined portion, thus making it possible to increase the strength of the damper supporting annular portion and thereby thin the damper supporting annular portion.

What is claimed is:

1. A disk reproducing device with a disk clamp mechanism comprising:
a turntable for rotating a disk placed thereon;
a damper for clamping the disk onto the turntable; and
a damper support plate for supporting the clamper,
wherein the clamper support plate is formed with a panel-like member constructed of an injection molded component, a damper mounting hole for receiving the damper is formed in the damper support plate, a clamper supporting annular portion which is thinner than the thickness of the clamper support plate is formed around a periphery of the clamper mounting hole, and an inclined portion having a predetermined inclination is formed around an outer edge of the damper supporting annular portion.

2. The disk reproducing device with a disk clamp mechanism according to claim 1, wherein the diameter of the most outer circumference of the damper supporting annular portion is substantially the same as an outer diameter of an upper brim portion of the clamper.
